(19) United States
(12) Patent Application Publication
(10) Pub. No.: US 2026/0296398 A1
(43) Pub. Date: Oct. 1, 2026

(54) SYSTEM AND METHOD FOR OPTIMIZING ENGINE TORQUE ON AXLE DISCONNECT DURING LIMITED BATTERY POWER FOR HYBRID VEHICLE

(71) Applicant: FCA US LLC, Auburn Hills, MI (US)

(72) Inventors: Nadirsh D Patel, Auburn Hills, MI (US); Hangxing Sha, Auburn Hills, MI (US); Krishna Chaitanya Reddy Madireddy, Auburn Hills, MI (US)

(21) Appl. No.: 19/095,123

(22) Filed: Mar. 31, 2025

(51) Int. Cl. B60W 20/15; B60W 10/02; B60W 10/06; B60W 10/08; B60W 10/119

(52) U.S. Cl. CPC B60W 20/15; B60W 10/06; B60W 10/08; B60W 10/119; B60W 10/02; B60W 2300/18; B60W 2710/025; B60W 2710/0666; B60W 2710/081; B60W 2710/083

(57) ABSTRACT

A powertrain control system for a range extended electric vehicle (REEV) is provided. The REEV has an internal combustion engine (ICE), a first electric motor associated with a first drive axle, a second electric motor associated with a second drive axle, and a disconnect device. The disconnect device has a first rotatable member coupled to the second electric motor and a second rotatable member coupled to the second drive axle, wherein the disconnect device moves between open and closed positions to communicate rotatable movement between the second electric motor and the second drive axle. The controller is configured to command the ICE to provide a torque input to facilitate a synching speed of the first and second rotatable members at the disconnect device.

### FIELD

The present application generally relates to hybrid electric vehicle control systems and, more particularly, to a method for optimizing engine torque on an axle disconnect device while battery power is limited.

### BACKGROUND

A hybrid-electric vehicle (HEV) powertrain typically includes an internal combustion engine, an electric traction motor, a high voltage battery system and a low voltage (e.g., 12 volt) battery system. In such a configuration, power generated from the engine and electric motor may be utilized to drive the vehicle, and the high voltage battery system is utilized to power the electric motor and power/recharge the low voltage battery system via a direct current to direct current (DC/DC) converter and a belt start generator (BSG). Some HEV powertrains, generally referred to as “range extended electric vehicles” (REEV's) are configured such that the internal combustion engine is disconnected from the driveline but is connected to the high voltage battery. These REEV's typically incorporate a first electric motor connected to a first axle (such as a rear axle) and a second electric motor connected to a second axle (such as a front axle). An axle disconnect device selectively connects and disconnects the second electric motor to the driveline. In this regard, the axle disconnect device disconnects the second electric motor from the axle in some conditions to save power of the high voltage battery. The axle disconnect device improves the efficiency of the battery power usage when it is disconnected and provides better drivability and performance to fulfill driver demand when connected. Under some power constrained operating conditions, there is insufficient power supplied to the second electric motor to effectively sync the speed of the second electric motor with the speed of the second axle with the disconnect device. As a result, the disconnect device engagement can take too long or eventually fail to engage resulting in degradation of drivability and vehicle level performance. Accordingly, while such conventional systems do work well for their intended purpose, there is a desire for improvement in the relevant art.

### SUMMARY

According to one example aspect of the invention, a powertrain control system for a range extended electric vehicle (REEV) is provided. The REEV has an internal combustion engine (ICE), a first electric motor associated with a first drive axle, a second electric motor associated with a second drive axle, and a disconnect device. The disconnect device has a first rotatable member coupled to the second electric motor and a second rotatable member coupled to the second drive axle, wherein the disconnect device moves between open and closed positions to communicate rotatable movement between the second electric motor and the second drive axle. The controller is configured to: command the disconnect device to one of open and close; determine a target motor speed for the second electric motor; determine a motor speed profile and a lead profile for the second electric motor; command a motor torque to the second electric motor based on the determined motor speed profile and the lead profile; and command an engine torque to the ICE, wherein the commanded motor torque and engine torque facilitate a synching speed of the first and second rotatable members at the disconnect device.

In some implementations, the controller is configured to determine whether the synching speed is achieved.

In some implementations, the controller is configured to determine whether a zero speed has been achieved at the second electric motor.

In some implementations the controller is configured to, command the disconnect device open and command a reduced engine torque to the ICE.

In some implementations, the controller is configured to command the disconnect device closed and command the ICE to one of generate more or less torque based on the determined motor speed profile and lead profile.

In additional aspects, the first electric motor provides torque input to a rear axle of the REEV.

In additional features, the second electric motor provides torque input to a front axle of the REEV.

In additional arrangements, a method for operating a powertrain control system for a range extended electric vehicle (REEV) is provided. The REEV has an internal combustion engine (ICE), a first electric motor associated with a first drive axle, and a second electric motor associated with a second drive axle, and a disconnect device having a first rotatable member coupled to the second electric motor and a second rotatable member coupled to the second drive axle, wherein the disconnect device moves between open and closed positions to communicate rotatable movement between the second electric motor and the second drive axle. The method includes: commanding, at a controller, the disconnect device to one of open and close; determining, at the controller, a target motor speed for the second electric motor; determining, at the controller, a motor speed profile and a lead profile for the second electric motor; commanding, at the controller, a motor torque to the second electric motor based on the determined motor speed profile and the lead profile; and commanding, at the controller, an engine torque to the ICE, wherein the commanded motor torque and engine torque facilitate a synching speed of the first and second rotatable members at the disconnect device.

In some examples, the method includes: determining, at the controller, whether the synching speed is achieved.

In implementations, the method includes: determining, at the controller, whether a zero speed has been achieved at the second electric motor.

In other examples, the controller commands the disconnect device closed and commands the ICE to one of generate more or less torque based on the determined motor speed profile and lead profile.

In additional aspects of the method, the first electric motor provides torque input to a rear axle of the REEV.

In additional features of the method, the second electric motor provides torque input to a front axle of the REEV.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a schematic illustration of an example hybrid electric vehicle (HEV) architecture in accordance with the principles of the present application;

FIG. 2 is a block diagram illustrating example motor speed acceleration constraints, raw target motor speed, and reserve target motor acceleration inputs involved to help engage or disengage a wheel end disconnect device of the HEV architecture of FIG. 1, in accordance with the principles of the present application;

FIG. 3 illustrates an example control logic flow for calculating motor speed profile and lead profile after commanding the disconnect device to close and determining whether a synchronized speed is achieved, in accordance with the principles of the present application; and

FIG. 4 illustrates an example control logic flow for calculating motor speed profile and lead profile after commanding the disconnect device to open and determining whether a zero motor speed is achieved, in accordance with the principles of the present application.

### DESCRIPTION

As discussed above, some HEV powertrains incorporate an axle disconnect device that selectively connects and disconnects an electric motor to the driveline. A range extended electric vehicle (REEV) includes a hybrid architecture that provides the benefits of a BEV architecture and relieves range anxiety that BEV sometimes have. These REEV's typically incorporate a first electric motor connected to a first or rear axle (hereinafter “rear axle electric motor”) and a second electric motor connected to a second or front axle (hereinafter “front axle electric motor”). An axle disconnect device (e.g., a clutch) selectively connects and disconnects the front axle electric motor to the driveline. In this regard, the axle disconnect device disconnects the front axle electric motor from the front axle in some conditions to save power of the high voltage battery. When connected (the clutch is closed), the front axle electric motor also provides drive torque for an all-wheel-drive operating arrangement.

The axle disconnect device improves the efficiency of the battery power usage when it is disconnected and provides better drivability and performance to fulfill driver demand when connected. Under some power constrained operating conditions, there is insufficient power supplied to the front axle electric motor to effectively synch the speed of the front axle electric motor with the speed of the front axle with the disconnect device. As a result, the disconnect device engagement can take too long or eventually fail to engage resulting in degradation of drivability and vehicle level performance.

During hybrid supervisory control, driver demand can be balanced with the engagement or disengagement of the axle disconnect device. Battery power is reserved for the axle disconnect device's engagement. However, when the battery power is limited, the power reserve would be taken away to deliver driver torque demand. For the driving scenarios where the power reserve is not enough and the battery power is limited, the engine generates more power for the disconnect clutch to spin up to the required synchronization speed for engagement.

The present disclosure provides a control method that utilizes the internal combustion engine to either generate more power to spin up the front axle electric motor faster under discharge limited scenarios, or generate less power to allow the front axle electric motor to spin down under charge limited scenarios. In particular, the control methods discussed herein address three distinct operating conditions including: a first scenario with discharge-limited battery power with axle disconnect engagement; a second scenario with charge-limited and hard braking with disconnect engagement; and a third scenario with charge-limited battery power with positive driver demand with disconnect disengagement.

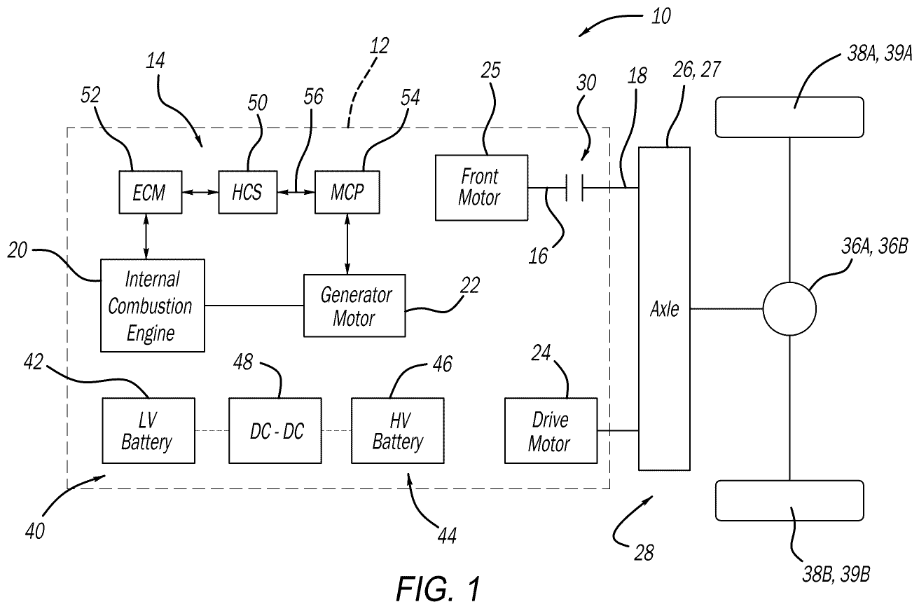

With initial reference to FIG. 1, a schematic diagram of a hybrid range extended electric vehicle (REEV) 10 is illustrated having a hybrid powertrain 12 and a powertrain control system 14 according to example implementations of the disclosure. In the illustrated example, the powertrain 12 generally includes an internal combustion engine 20 and three electric motors, including a low voltage (e.g., 12V) belt-driven starter generator (BSG) and inverter unit 22 (BSG motor), a higher voltage (e.g., 400V) electric drive or traction motor 24 (e.g., rear axle electric motor), and a disconnect motor or front axle electric motor 25. It will be appreciated that the illustrated configuration is merely exemplary, and the techniques described herein may be applied to various hybrid vehicle powertrain configurations. Furthermore, while the following description assigns “front” and “rear”, the hardware and associated components may be switched or configured differently.

In the example embodiment, the engine 20 combusts a mixture of air and fuel (e.g., gasoline) within cylinders to drive pistons and generate power to charge a high voltage battery 46. The drive torque provided by the rear and front electric motors 24, 25 is ultimately transferred to rear wheels 38A, 38B, and front drive wheels 39A, 39B by way of a driveline 28. Drive torque is provided by the rear axle electric motor 24 to a rear axle 26 that is coupled through a rear differential 36A to the rear drive wheels 38A, 38B. Additional drive torque can further be provided by the front axle electric motor 25 to a front axle 27 that is coupled through a front differential 36B to the front drive wheels 39A, 39B.

A disconnect device or clutch 30 moves between open and closed positions to rotatably connect a first rotatable clutch member 16 and a second rotatable clutch member 18. The first rotatable clutch member 16 is coupled to the front axle electric motor 25. The second rotatable clutch member 18 is coupled to the front axle 27. The electric motor of the BSG unit 22 is utilized to control engine stop/start operations to improve vehicle fuel economy.

To provide electric power, the HEV 10 includes a low voltage battery system 40 having a battery 42, and a high voltage (HV) battery system 44 having a HV traction battery 46. In the example description, the low voltage battery system 40 is a 12V system and the HV battery system 44 is a 400V system and will be described as such. However, it will be appreciated that battery systems 40, 44 may have different operating voltages.

In the example embodiment, the low voltage battery system 40 is configured to support various 12V loads of the HEV 10, for example, to power various electrical components or start the engine 20. The HV battery system 44 is configured to power high voltage loads such as the front and rear electric motors 24 and 25 and a DC/DC converter 48. In general, the low voltage BSG unit 22 is powered by the low voltage battery system 40 and/or the HV battery system 44. The DC/DC converter 48 is an actuator configured to convert high voltage (e.g., 48V) to low voltage (e.g., 12V) to charge the 12V battery 42 and support various 12V loads of the HEV 10.

In the example embodiment, the hybrid powertrain 12 is controlled by the powertrain control system 14, which generally includes a hybrid supervisory control system module (HCS) or controller 50, an engine control module (ECM) or controller 52, and a motor control processor (MCP) 54. The HCS 50 is a central supervisory control configured to communicate with various components/modules of the hybrid powertrain 12 via a CAN bus 56. The ECM 52 is configured to control engine 20 to provide torque and speed, for example, to drive the 12V BSG unit 22. The HCS 50 is configured to control and monitor the engine 20 via the ECM 52, and control electric motor 24 via the MCP 54.

The BSG unit 22 is an actuator configured to be utilized as a starter when the HEV 10 needs to crank the engine 20. The BSG unit 22 is configured to operate in an alternator mode to charge the 12V battery 42 and support 12V loads while the engine 20 is running. The BSG unit 22 is directly controlled by the MCP 54, which is a controller configured for bi-directional communication with the HCS 50 via the CAN bus 56. The HCS 50 is configured to control the electric motor 24 by forwarding signals, such as operation state, torque command, and voltage setpoints to the MCP 54, and the MCP 54 provides feedback signals to the HCS 50 related to the electric motor 24, such as operation status, output current, and voltage.

In a REEV, the internal combustion engine 20 is used to charge the HV battery 46 of the HV battery system 42. According to the present disclosure, the internal combustion engine 20 is also used to provide a rotatable input to the front axle electric motor 25. In one example, the internal combustion engine 20 is used to generate more power at the front axle electric motor 25 to spin up the first rotatable clutch member 16. In another example, the internal combustion engine 20 is used to generate less power at the front axle electric motor 25 to spin down the first rotatable clutch member 16.

The three operating scenarios identified above will be described in greater detail. In the first scenario, axle disconnect engagement with discharge-limited battery power will be described. In a discharge-limited battery power situation, the HV battery 46 does not have enough power to accelerate the front axle electric motor 25. When the discharge power of the HV battery 46 is constrained, the HCS 50 must try and maintain driver demand while simultaneously using power to spin up the axle disconnect motor 25 to the synchronization speed required for engagement of the clutch 30. This prioritization can lead to a compromise in driver torque delivery, resulting in a perceived decrease in acceleration and a feeling of deceleration, even when the driver requests increased acceleration. To avoid such case, torque from the internal combustion engine 20 is increased to provide the additional power.

In the second scenario, hard braking with disconnect engagement and with a charge-limited HV battery 46 will be described. In a charge-limited HV battery condition, the HV battery 46 is full or according to another scenario cannot otherwise accept charge. When the driver initiates a hard brake event while the disconnect device 30 is attempting to engage, the HCS 50 must decelerate the speed of the front motor 25 to match the vehicle's deceleration rate and synchronize the disconnect clutch 30. However, if the HV battery 46 is charge-limited, there may not be sufficient authority for the profiler to achieve this deceleration, potentially causing it to compete with the braking force and delaying the synchronization needed for disconnect engagement. To avoid such case, torque from the internal combustion engine 20 is decreased to provide a reduction in power.

In the third scenario, with charge-limited power of the HV battery 46, positive driver demand and disengagement of the clutch 30 will be described. In this scenario, when the HV battery 46 is charge-limited, the HCS 50 needs to maintain a positive driver demand while spinning down the front axle electric motor 25. This action allows the additional power generated from spinning down the front axle electric motor 25 to mitigate noise, vibration, and harshness (NVH) issues. However, this can inadvertently increase the torque delivered to the driver demand, leading to a “push” sensation for the driver. To address these challenges, the internal combustion engine 20 and generator 22 can be utilized to provide additional power, enabling faster acceleration of the disconnect device 30 for quicker engagement in the first and second scenarios. Conversely, they can also absorb power to facilitate faster deceleration of the disconnect device 30, aiding in engagement or spinning down as needed in this third scenario.

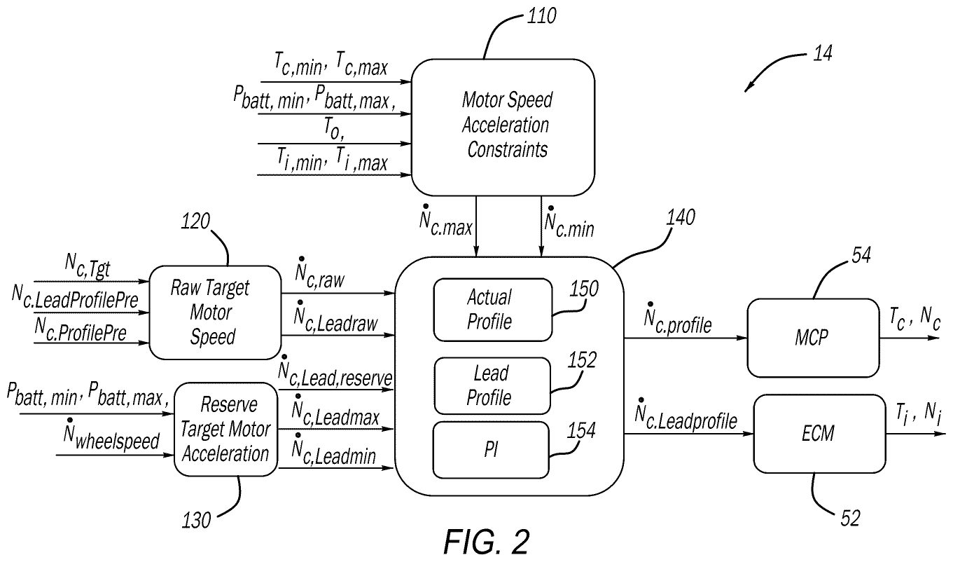

With additional reference to FIG. 2, the powertrain control system 14 that uses the internal combustion engine 20 to help engage or disengage the disconnect device 30 is shown in more detail. The powertrain control system 14 generally includes a motor speed acceleration constraints module 110, a raw target motor speed module 120, a reverse target motor acceleration module 130 and a profile controller 140. The raw target motor speed module 120 determines motor limit accelerations of the front axle electric motor 25. The reverse target motor acceleration module 130 determines limits of the HV battery 46.

The internal combustion engine 20 and the generator motor 22 are functioning as a generator to provide charging power to the HV battery 46 or it could absorb power:

$${P}_{1 f} * {T}_{a} + {T}_{i} = ( {P}_{1 f}^{2} * {I}_{a} + {I}_{e} ) * {\dot{N}}_{ι} + ( {P}_{1 f}^{2} * {B}_{a} + {B}_{e} ) * {N}_{i} \qquad ( 1 )$$

Where, P_{1f} is ratio between the engine 20 and the generator motor 22, Iₐ, Iₑ, Bₐ, Bₑ are the inertias and damping of the generator motor 22 and engine 20, respectively, wherein Tₐ represents generator torque, Tᵢ represents engine torque, Nᵢ, \dot{N}₁ represent engine speed and acceleration, respectively.

When the disconnect clutch 30 is open, the disconnect motor 25 torque is a function of motor speed and acceleration:

$${T}_{c} = {I}_{c} * {\dot{N}}_{c} + {B}_{c} * {N}_{c} \qquad ( 2 )$$

And drive (rear)motor 24 is delivering the driver demand:

$${T}_{o} = {T}_{or} = {FDR}_{r} * {T}_{b} - ( {FDR}_{r}^{2} * {I}_{b} ) * {\dot{N}}_{o} - ( {FDR}_{r}^{2} * {B}_{b} ) * {N}_{o} \qquad ( 3 )$$

And from power domain:

$${P}_{bat} = {P}_{A} + {P}_{B} + {P}_{c} \qquad ( 4 )$$

During the engagement of the clutch 30, the disconnect motor 25 is spinning up to sync the motor speed to the wheel speed and be ready to engage the disconnect clutch 30. HV battery 46 power is used to deliver driver torque request and spin the disconnect motor 25 at the same time. To deliver the achievable motor acceleration profiler, the HCS 50 calculates the acceleration limit based on the power limit of the HV battery 46, actuator limits and driver demand. The motor speed profiler calculation in shift execution subsystem will post either max or min limit on the motor speed acceleration.

$${\dot{N}}_{c , raw} = ( {N}_{c , Tgt} - {N}_{c , ProfilePre} ) \qquad ( 5 )$$

The raw acceleration profile is limited with constraint limits.

$${\dot{N}}_{c , Profile} = min max ( {\dot{N}}_{c , raw} , {\dot{N}}_{c , max} , {\dot{N}}_{c , min} ) \qquad ( 6 )$$

$${N}_{c , Profile} = {N}_{c , ProfilePre} + {\dot{N}}_{c , Profile} \qquad ( 7 )$$

In the power constraint scenarios, the profile increasing/decreasing rate will be limited. The lead profile module 152 calculates how much more or less power that the motor 25 is needed to accelerate or decelerate faster. To calculate the lead profile, the lead profile limits are needed. Motor power calculation is using:

$${P}_{motor} = {( {A}_{1} * {\dot{N}}_{c} * {I}_{c} + {A}_{2} )}^{2} + C \qquad ( 8 )$$

Based on the motor power calculation, the HCS 50 needs to back calculate the reserve motor speed acceleration that is needed to spin up the motor 25 to the target speed by solving the quadratic equation as shown in equation (8)

$${\dot{N}}_{cLead , reserve} = \frac{\sqrt{{P}_{motorReserve} - C} - {A}_{2}}{{A}_{1} * {I}_{c}} \qquad ( 9 )$$

The reserve motor speed acceleration is used for the lead profiler to make sure the actual profile should at least accelerate at this rate to ensure an appropriate closing. The additional power is only needed when there is not enough power to accelerate the disconnect motor 25 to meet the minimum acceleration. When the discharge power of the HV battery 46 is less than the reserve power, the lead profile module of the profile controller 140 needs to open \dot{N}_{c} using \dot{N}_{cLead,max} to send additional acceleration request to the engine controller 52 asking for additional power.

$${\dot{N}}_{cLead , max} = \frac{\sqrt{( {P}_{motorReserve} - {P}_{max} ) - C} - {A}_{2}}{{A}_{1} * {I}_{c}} \qquad ( 10 )$$

When the target speed is decelerating, the disconnect motor 25 needs to at least match the deceleration rate. When the charge power of the HV battery 46 is higher than the power that motor is needed to match up with the deceleration rate, the lead profiler controller needs to allow more negative \dot{N}_{c} using \dot{N}_{cLead,min}.

$${\dot{N}}_{cLead , min} = \frac{\sqrt{( {P}_{min} - {P}_{vehicledecel} ) - C} - {A}_{2}}{{A}_{1} * {I}_{c}} \qquad ( 11 )$$

$$where {P}_{vehicledecel} = {( {A}_{1} * {\dot{N}}_{wheelspeed} * {I}_{c} + {A}_{2} )}^{2} + C$$

For the lead profile, the raw acceleration is also based on the target speed and the previous loop lead profile.

$${\dot{N}}_{c , Leadraw} = ( {N}_{c , Tgt} - {N}_{c , LeadProfilePre} ) \qquad ( 12 )$$

The lead profile will also honor the system constraint limits that are applied to the actual profile. But it would allow \dot{N}_{c,LeadProfileraw} to honor the \dot{N}_{cLead,reserve} when the actual \dot{N}_{c,max} is smaller than the \dot{N}_{cLead,reserve} so that additional request can be sent to engine optimal system asking for more power. And it is similarly on the min side, the lead profiler would allow the \dot{N}_{c,LeadProfileraw} to honor \dot{N}_{cLead,min} when the actual profile min is limited.

$${\dot{N}}_{c , LeadProfileraw} = min max [ {\dot{N}}_{c , leadraw} , max ( {\dot{N}}_{c , max} , {\dot{N}}_{c , Lead , reserve} ) , min ( {\dot{N}}_{c , min} , {\dot{N}}_{c , Lead , min} ) ] \qquad ( 13 )$$

The actual lead profile will be calculated based on the previous loop Lead profile and acceleration term within the limits.

$${N}_{c , LeadProfile} = {N}_{c , LeadProfilePre} + {\dot{N}}_{c , LeadProfileraw} \qquad ( 14 )$$

The open loop acceleration term that is sent to engine optimal system is limited with the \dot{N}_{cLead,max} since if there is enough power to achieve the acceleration from the motor power reserve there is no need to ask engine optimal system to deliver additional power.

$${\dot{N}}_{c , LeadProfileOP} = min ( {\dot{N}}_{cLead , max} , {\dot{N}}_{c , LeadProfileraw} ) \qquad ( 15 )$$

The open loop might not be sufficient bring the actual profile to the lead profile. A controller such as a proportional-integral-derivative (PI) controller is added to provide the additional power.

$${\dot{N}}_{c , LeadProfileCL} = PGain * ( {N}_{c , LeadProfile} - {N}_{c , Profile} ) + \int IGain * ( {N}_{c , LeadProfile} - {N}_{c , Profile} ) \qquad ( 16 )$$

The total acceleration lead profile that is sent to the engine optimal system includes both the open loop and close loop term.

$${\dot{N}}_{c , LeadProfile} = {\dot{N}}_{c , LeadProfileOP} + {\dot{N}}_{c , LeadProfileCL} \qquad ( 17 )$$

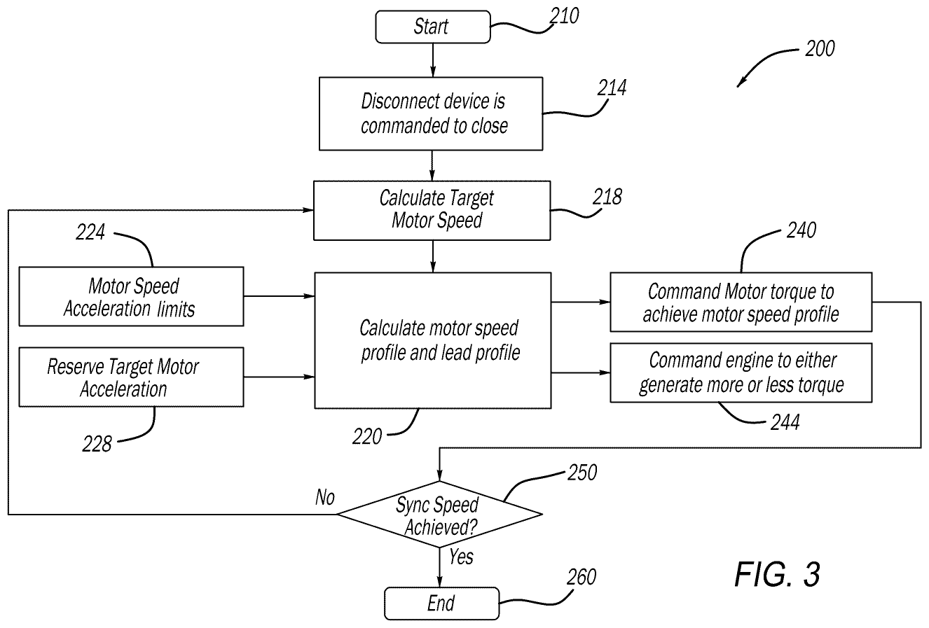

With additional reference now to FIG. 3, an example control logic flow 200 for calculating motor speed profile and lead profile after commanding the disconnect device 30 to close and determining whether a synchronized speed is achieved will be described in accordance with the principles of the present application. Control starts at 210. At 214, control commands the disconnect device 30 to close. At 218, control calculates a target motor speed. At 220, control calculates a motor speed profile and a lead profile based on a motor speed acceleration limits input 224 and reserve target motor acceleration inputs 228. At 240 control commands motor torque to achieve a motor speed profile. At 244 control commands the engine 20 to either generate more or less torque. At 250 control determines whether a synchronization speed is achieved. If not, control loops to 218. If a synchronization speed has been achieved, control ends at 260.

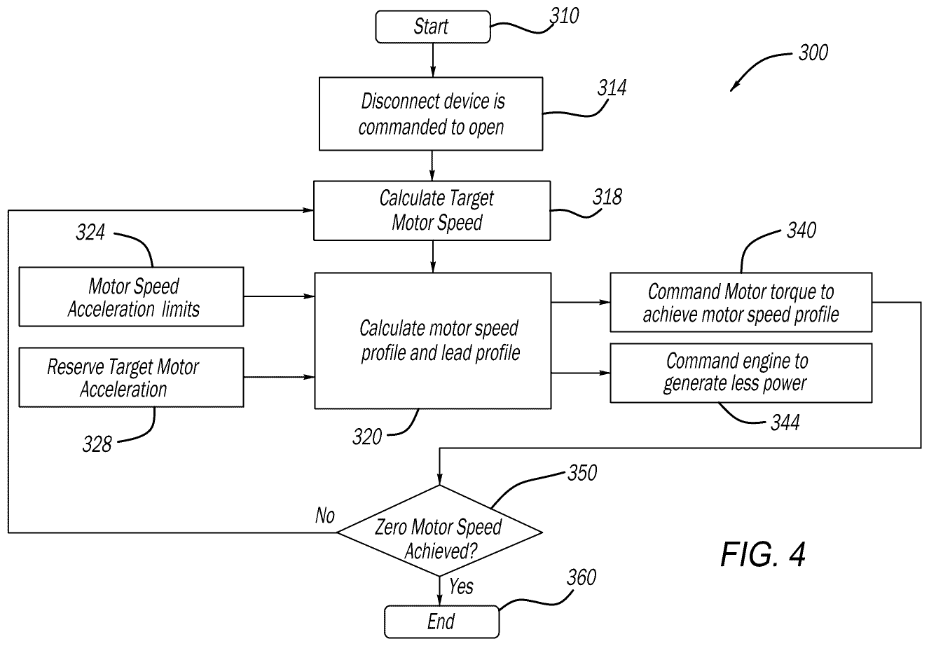

With additional reference to FIG. 4, an example control logic flow 300 for calculating motor speed profile and lead profile after commanding the disconnect device 30 to open and determining whether a zero motor speed is achieved, in accordance with the principles of the present application. Control starts at 310. At 314, control commands the disconnect device 30 to open. At 318, control calculates a target motor speed. At 320, control calculates a motor speed profile and a lead profile based on a motor speed acceleration limits input 324 and reserve target motor acceleration inputs 328. At 340 control commands motor torque to achieve a motor speed profile. At 344 control commands the engine 20 to generate less power. At 350 control determines whether a zero motor speed is achieved. If not, control loops to 318. If a zero motor speed has been achieved, control ends at 360.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A powertrain control system for a range extended electric vehicle (REEV), the REEV having an internal combustion engine (ICE), a first electric motor associated with a first drive axle, and a second electric motor associated with a second drive axle, the powertrain control system comprising:
a disconnect device having a first rotatable member coupled to the second electric motor and a second rotatable member coupled to the second drive axle, wherein the disconnect device moves between open and closed positions to communicate rotatable movement between the second electric motor and the second drive axle; and
a controller configured to:
command the disconnect device to one of open and close;
determine a target motor speed for the second electric motor;
determine a motor speed profile and a lead profile for the second electric motor;
command a motor torque to the second electric motor based on the determined motor speed profile and the lead profile; and
command an engine torque to the ICE, wherein the commanded motor torque and engine torque facilitate a synching speed of the first and second rotatable members at the disconnect device.

2. The powertrain control system of claim 1, wherein the controller is further configured to:
determine whether the synching speed is achieved.

3. The powertrain control system of claim 1, wherein the controller is further configured to:
determine whether a zero speed has been achieved at the second electric motor.

4. The powertrain control system of claim 1, wherein the controller is configured to command the disconnect device open and command a reduced engine torque to the ICE.

5. The powertrain control system of claim 1, wherein the controller is configured to command the disconnect device closed and command the ICE to one of generate more or less torque based on the determined motor speed profile and lead profile.

6. The powertrain control system of claim 1, wherein the first electric motor provides torque input to a rear axle of the REEV.

7. The powertrain control system of claim 1, wherein the second electric motor provides torque input to a front axle of the REEV.

8. A method for operating a powertrain control system for a range extended electric vehicle (REEV), the REEV having an internal combustion engine (ICE), a first electric motor associated with a first drive axle, and a second electric motor associated with a second drive axle, and a disconnect device having a first rotatable member coupled to the second electric motor and a second rotatable member coupled to the second drive axle, wherein the disconnect device moves between open and closed positions to communicate rotatable movement between the second electric motor and the second drive axle, the method comprising:
commanding, at a controller, the disconnect device to one of open and close;
determining, at the controller, a target motor speed for the second electric motor;
determining, at the controller, a motor speed profile and a lead profile for the second electric motor;
commanding, at the controller, a motor torque to the second electric motor based on the determined motor speed profile and the lead profile; and
commanding, at the controller, an engine torque to the ICE, wherein the commanded motor torque and engine torque facilitate a synching speed of the first and second rotatable members at the disconnect device.

9. The method of claim 8, further comprising:
determining, at the controller, whether the synching speed is achieved.

10. The method of claim 8, further comprising:
determining, at the controller, whether a zero speed has been achieved at the second electric motor.

11. The method of claim 8, wherein the controller commands the disconnect device closed and commands the ICE to one of generate more or less torque based on the determined motor speed profile and lead profile.

12. The method of claim 8, wherein the first electric motor provides torque input to a rear axle of the REEV.

13. The method of claim 8, wherein the second electric motor provides torque input to a front axle of the REEV.
